(19) United States
(12) Patent Application Publication
(10) Pub. No.: US 2025/0379455 A1
(43) Pub. Date: Dec. 11, 2025

(54) ADJUSTING A STATE OF CHARGE LIMIT OF A BATTERY STACK BASED ON A STATE OF HEALTH OF THE BATTERY STACK

(71) Applicant: MILWAUKEE ELECTRIC TOOL CORPORATION, Brookfield, WI (US)

(72) Inventors: Ryan B. Jipp, Brookfield, WI (US); Jonathan Quenzer, German Valley, IL (US)

(21) Appl. No.: 19/230,470

(22) Filed: Jun. 6, 2025

Related U.S. Application Data
(60) Provisional application No. 63/657,611, filed on Jun. 7, 2024.

(51) Int. Cl. H02J 7/00

(52) U.S. Cl. CPC H02J 7/0013; H02J 7/005

(57) ABSTRACT

A battery pack comprising a battery stack and a controller electrically connected to the battery stack. The controller is configured to determine a state of health of the battery stack and adjust a state of charge (SOC) limit for the battery stack based on the determined state of health.

### SUMMARY

Regulatory agencies impose limits on battery capacity or regulate batteries that exceed specified capacity thresholds. For example, the Federal Aviation Administration (FAA) and the Transportation Security Administration (TSA) specify that batteries with capacity greater than or equal to 160 Watt-hours (Wh) cannot be brought onto passenger planes. The Department of Transportation (DOT) specifies that batteries with capacity greater than or equal to 300 Wh must be shipped via highway and railway as a Class 9 hazardous material. As another example, batteries with a capacity greater than or equal to 1000 Wh must pass cell propagation requirements specified by the standards established by, for example, Underwriters Laboratories (UL)/International Electrotechnical Commission (IEC) (i.e. UL2743, IEC62368).

As batteries become capable of greater capacity, artificial charge and/or discharge limits (referred to herein as a state of charge (SOC) limit) are commonly imposed on cells/packs to prevent batteries from exceeding capacity thresholds specified by regulatory agencies. For example, a battery that has a capacity of 309 Wh when it is allowed to fully charge and discharge may have its charging and/or discharging capabilities limited so that the initial capacity of the battery does not exceed 299 Wh. Therefore, this battery avoids being classified as a Class 9 hazardous material when it is shipped by rail.

However, as a battery ages and is repeatedly charged and discharged, the capacity of the battery decreases naturally and it is desirable to modify the state of charge limits set for the battery to prevent the battery from exceeding capacity thresholds specified by regulatory agencies.

Thus, embodiments described herein provide systems and methods for adjusting a state of charge limit of a battery stack based on a state of health of the battery stack.

One example embodiment provides a battery pack comprising a battery stack and a controller electrically connected to the battery stack. The controller is configured to determine a state of health of the battery stack and adjust a state of charge (SOC) limit for the battery stack based on the determined state of health.

Another example embodiment provides a method for adjusting a state of charge (SOC) limit of a battery stack based on a state of health of the battery stack. The method includes determining a state of health of a battery stack and adjusting a SOC limit for the battery stack based on the determined state of health.

Before any embodiments are explained in detail, the embodiments are not limited in their application to the details of the configuration and arrangement of components set forth in the following description or illustrated in the accompanying drawings. The embodiments are capable of being practiced or of being carried out in various ways. Also, the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, embodiments may include hardware, software, and electronic components or modules that, for purposes of discussion, may be illustrated and described as if the majority of the components were implemented solely in hardware. However, one of ordinary skill in the art, based on a reading of this detailed description, would recognize that in at least some embodiments, the electronic-based aspects may be implemented in software (e.g., stored on non-transitory computer-readable medium) executable by one or more processing units, such as a microprocessor and/or application specific integrated circuits (“ASICs”). As such, a plurality of hardware and software based devices, as well as a plurality of different structural components, may be utilized to implement the embodiments. For example, “servers” and “computing devices” described in the specification can include one or more processing units, one or more computer-readable medium modules, one or more input/output interfaces, and various connections (e.g., a system bus) connecting the components.

Also, the illustrated components, unless explicitly described to the contrary, may be combined or divided into separate software, firmware and/or hardware. For example, instead of being located within and performed by a single electronic processor, logic and processing described herein may be distributed among multiple electronic processors. Similarly, one or more memory modules and communication channels or networks may be used even if embodiments described or illustrated herein have a single such device or element. Also, regardless of how they are combined or divided, hardware and software components may be located on the same computing device or may be distributed among multiple different devices. Accordingly, in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

Other features and aspects will become apparent by consideration of the following detailed description and accompanying drawings.

### BRIEF DESCRIPTION OF THE DRAWINGS

FIG. 1 illustrates a power tool battery pack in accordance with embodiments described herein.

FIG. 2 illustrates a block diagram of a controller for the battery pack of FIG. 1 in accordance with embodiments described herein.

FIG. 3 illustrates a power tool charger in accordance with embodiments described herein.

FIG. 4 illustrates a block diagram of a controller for the power tool charger of FIG. 3 in accordance with embodiments described herein.

FIG. 5 provides an example illustration of usable energy in a single cell of a battery when no SOC limit is placed on the battery cell to prevent a capacity of the battery cell from meeting or exceeding a threshold capacity set by a regulatory agency.

FIG. 6A-FIG. 6C each illustrate a different approach to placing a SOC limit on a battery cell to prevent a capacity of the battery cell from meeting or exceeding a threshold capacity set by a regulatory agency.

FIG. 7 provides an example illustration of a method for adjusting a state of charge limit of a battery stack based on a state of health of the battery stack in accordance with embodiments described herein.

FIG. 8 provides an example graph illustrating how the state of health of a battery stack effects the state of charge set for the battery stack and the percentage of the battery stack's energy that is usable in accordance with embodiments described herein.

FIG. 9 provides an example flowchart of a method for adjusting a state of charge limit of a battery stack based on a state of health of the battery stack in accordance with embodiments described herein.

FIG. 10 provides an example graph that illustrates how the state of health of a battery stack effects the state of charge limit set for the battery stack and the percentage of the battery stack's energy that is usable in accordance with embodiments described herein.

### DETAILED DESCRIPTION

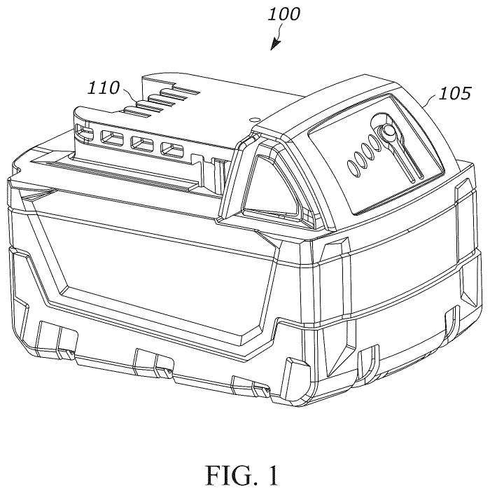

FIG. 1 illustrates a battery pack 100 according to some embodiments. The battery pack 100 includes a battery pack housing 105 and a power tool interface 110. The power tool interface 110 is configured to couple the battery pack 100 to a power tool device. The battery pack 100 provides the power tool with operating power using the power tool interface 110.

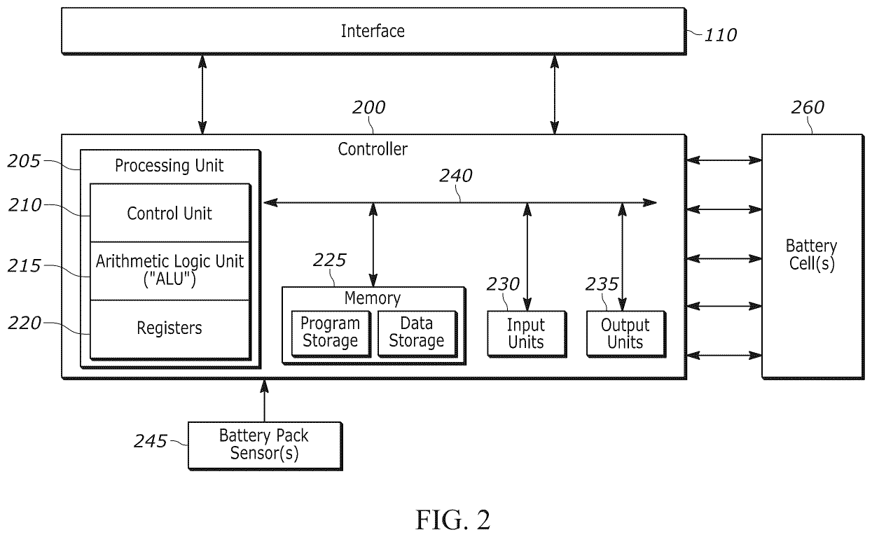

A battery pack controller 200 for the battery pack 100 is illustrated in FIG. 2. The battery pack controller 200 is electrically and/or communicatively connected to a variety of modules or components of the battery pack 100. For example, the illustrated battery pack controller 200 is connected to one or more battery pack sensors 245, a battery stack 260, and the power tool interface 110.

The battery pack controller 200 includes a plurality of electrical and electronic components that provide power, operational control, and protection to the components and modules within the battery pack controller 200 and/or battery pack 100. For example, the battery pack controller 200 includes, among other things, a processing unit 205 (e.g., a microprocessor, an electronic processor, an electronic controller, a microcontroller, or another suitable programmable device), a memory 225, input units 230, and output units 235. The processing unit 205 includes, among other things, a control unit 210, an arithmetic logic unit (“ALU”) 215, and a plurality of registers 220 (shown as a group of registers in FIG. 2), and is implemented using a known computer architecture (e.g., a modified Harvard architecture, a von Neumann architecture, etc.). The processing unit 205, the memory 225, the input units 230, and the output units 235, as well as the various modules connected to the battery pack controller 200 are connected by one or more control and/or data buses (e.g., common bus 240). The control and/or data buses are shown generally in FIG. 2 for illustrative purposes. The use of one or more control and/or data buses for the interconnection between and communication among the various modules and components would be known to a person skilled in the art in view of the embodiments described herein.

The memory 225 is a non-transitory computer-readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 205 is connected to the memory 225 and executes software instructions that are capable of being stored in a RAM of the memory 225 (e.g., during execution), a ROM of the memory 225 (e.g., on a generally permanent basis), or another non-transitory computer-readable medium such as another memory or a disc. Software included in the implementation of the battery pack 100 can be stored in the memory 225 of the battery pack controller 200. The software includes, for example, firmware, one or more applications, program data, filters, rules, one or more program modules, and other executable instructions. The battery pack controller 200 is configured to retrieve from the memory 225 and execute, among other things, instructions related to the control processes and methods described herein. In other embodiments, the battery pack controller 200 includes additional, fewer, or different components.

The battery pack controller 200 is powered by the battery stack 260, and provides power (e.g., current and voltage) to the power tool interface 110 using the battery stack 260. The battery stack 260 includes one or more battery cells (e.g., a plurality of battery cells) in a particular configuration (e.g., series, parallel, series-parallel configurations). The battery pack sensor(s) 245 are configured to monitor charge voltage, charge current, discharge voltage, and discharge current of the battery cell(s) of the battery stack 260 individually or collectively.

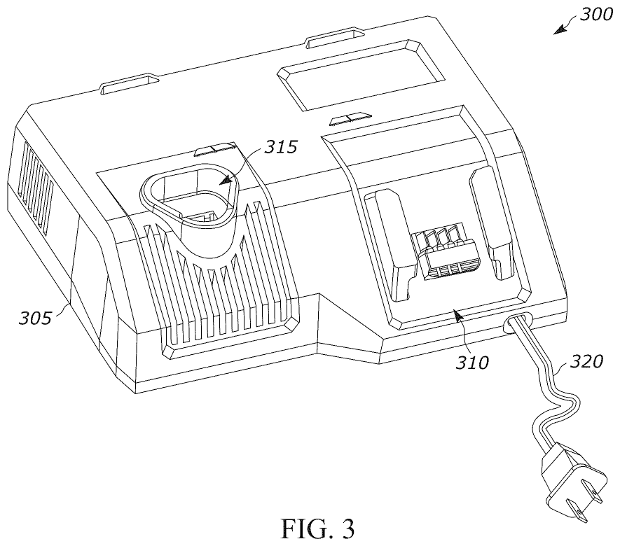

FIG. 3 illustrates a battery pack charger 300. The battery pack charger 300 includes a housing 305 and interface portions 310, 315 for connecting the battery pack charger 300 to one or more battery packs (e.g., battery pack 100). The battery pack charger 300 also includes a power cable 320 for coupling to an AC power source.

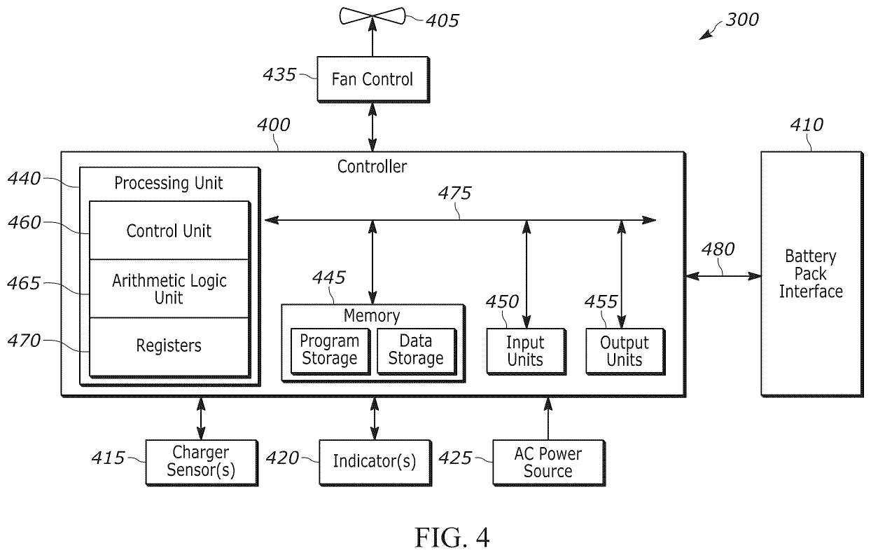

FIG. 4 illustrates a control system for the battery pack charger 300. The control system includes a charger controller 400. The charger controller 400 is electrically and/or communicatively connected to a variety of modules or components of the battery pack charger 300. For example, the illustrated charger controller 400 is electrically connected to a fan 405, a battery pack interface 410 (e.g., interface portions 310, 315), one or more charger sensors or charger sensing circuits 415 (e.g., voltage sensors, current sensors, temperature sensors, etc.), one or more indicators 420, a fan control module or circuit 435, and an AC power source 425. The charger controller 400 includes combinations of hardware and software that are operable to, among other things, control the operation of the battery pack charger 300, determine a temperature of a heatsink, activate the indicators 420 (e.g., one or more LEDs), etc.

The charger controller 400 includes a plurality of electrical and electronic components that provide power, operational control, and protection to the components and modules within the charger controller 400 and/or battery pack charger 300. For example, the charger controller 400 includes, among other things, a processing unit 440 (e.g., a microprocessor, a microcontroller, or another suitable programmable device), a memory 445, input units 450, and output units 455. The processing unit 440 includes, among other things, a control unit 460, an ALU 465, and a plurality of registers 470 (shown as a group of registers in FIG. 4), and is implemented using a known computer architecture (e.g., a modified Harvard architecture, a von Neumann architecture, etc.). The processing unit 440, the memory 445, the input units 450, and the output units 455, as well as the various modules or circuits connected to the controller 400, are connected by one or more control and/or data buses (e.g., common bus 475). The control and/or data buses are shown generally in FIG. 4 for illustrative purposes. The use of one or more control and/or data buses for the interconnection between and communication among the various modules, circuits, and components would be known to a person skilled in the art in view of the invention described herein.

The memory 445 is a non-transitory computer-readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 440 is connected to the memory 445 and executes software instructions that are capable of being stored in a RAM of the memory 445 (e.g., during execution), a ROM of the memory 445 (e.g., on a generally permanent basis), or another non-transitory computer-readable medium such as another memory or a disc. Software included in the implementation of the battery pack charger 300 can be stored in the memory 445 of the charger controller 400. The software includes, for example, firmware, one or more applications, program data, filters, rules, one or more program modules, and other executable instructions. The charger controller 400 is configured to retrieve from the memory 445 and execute, among other things, instructions related to the control processes and methods described herein. In other constructions, the charger controller 400 includes additional, fewer, or different components.

The battery pack interface 410 includes a combination of mechanical components (e.g., rails, grooves, latches, etc.) and electrical components (e.g., one or more terminals) configured to and operable for interfacing (e.g., mechanically, electrically, and communicatively connecting) the battery pack charger 300 with a battery pack (e.g., battery pack 100). For example, the battery pack interface 410 is configured to receive power via a power line between the AC power source 425 and the battery pack interface 410. The battery pack interface 410 is also configured to communicatively connect to the charger controller 400 via a communications line 480.

In some embodiments, the charger controller 400 is configured to determine whether a fault condition of the battery pack charger 300 is present and generate one or more control signals related to the fault condition. For example, the charger sensing circuits 415 include one or more current sensors, one or more temperature sensors, one or more voltage sensors, etc. The charger controller 400 is configured to detect an over current condition (e.g., when charging the battery pack 100), an over temperature condition, etc. If the charger controller 400 detects one or more fault conditions of the battery pack charger 300 or determines that a fault condition of the battery pack charger 300 no longer exists, the charger controller 400 is configured to provide information and/or control signals to another component of the battery pack charger 300 (e.g., the battery pack interface 410, etc.)

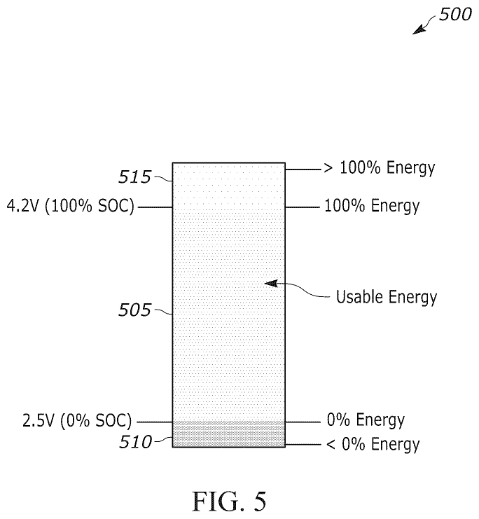

FIG. 5 provides an example illustration of usable energy in a single cell of a battery 500 (for example, a battery cell of the battery stack 260) when no SOC limit is placed on the battery cell 500 to prevent the battery capacity from meeting or exceeding a threshold capacity set by a regulatory agency. In the example illustrated in FIG. 4, the battery cell 500 has a maximum charging voltage of 4.2 V (in other words, the state of charge (SOC) of the battery cell 500 is 100 percent when the battery cell 500 is charged to 4.2V) and the cell 500 has a minimum discharge voltage of 2.5 V (in other words, the SOC of the battery cell 500 is 0 percent when the battery cell 500 is discharged to 2.5V). The maximum charging voltage and the minimum discharge voltage are set by manufacturers of the battery cells 500. When the SOC of the battery cell 500 is 100 percent, the percent of energy (measured in, for example, Wh) remaining in the battery cell 500 is 100 percent. When the SOC of the battery cell 500 is 0 percent, the percent of energy remaining in the battery cell 500 is 0 percent (0 Wh).

In FIG. 5, the portion of the battery cell 500 marked 505 represents the usable energy of the battery cell 500. The portion 510 represents unusable energy included in the battery cell 500. If the energy represented by the portion 510 is used, the life of the battery cell 500 may be shortened. The portion 515 also represents unusable energy that the battery cell 500 is capable of storing. If the battery cell 500 is charged to include the energy represented by the portion 515, the life of the battery cell 500 may be shortened or the battery cell 500 may become unsafe. Thus, while the battery cell 500 of FIG. 5 does not have a charge limit and/or discharge limit (i.e., SOC limit) placed on it to prevent the battery capacity from meeting or exceeding a threshold capacity set by a regulatory agency, the battery cell 500 does have a charge limit and a discharge limit placed on it that aid in preventing the battery cell 500 from becoming unsafe and preventing the life of the battery cell 500 being shortened. When SOC limits are generally discussed in the application below, they do not refer to SOC limits that aid in preventing the battery cell 500 from becoming unsafe and preventing the life of the battery cell 500 being shortened. Additionally, when a battery or battery cell is described below as having a percentage of energy available or useable, that energy does not include the energy represented by the portion 510 and the portion 515.

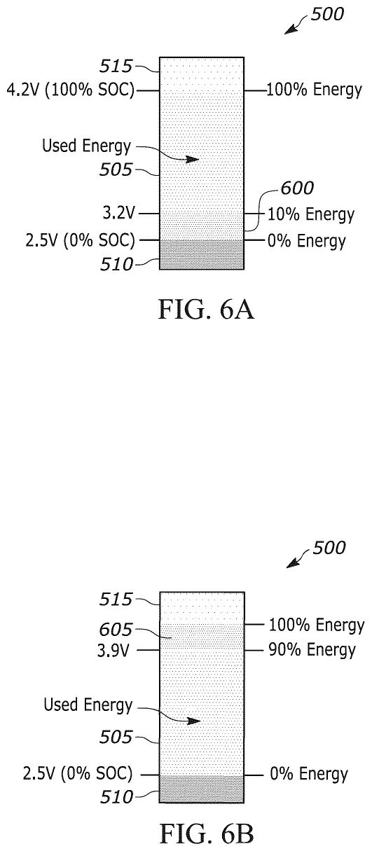

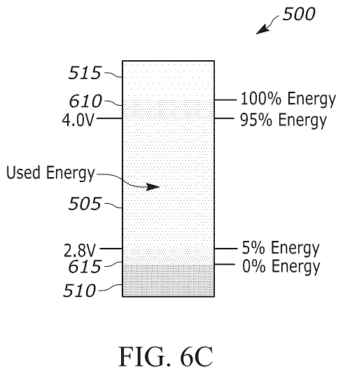

FIG. 6A-FIG. 6C illustrate three different approaches to placing a SOC limit on a battery cell to prevent the battery cell's capacity from meeting or exceeding a threshold capacity set by a regulatory agency.

FIG. 6A illustrates the approach of placing a discharge limit (e.g., a SOC limit) on a battery cell (for example, battery cell(s) 500 of the battery stack 260) to prevent the battery cell's capacity from meeting or exceeding a threshold capacity set by a regulatory agency. In FIG. 6A, the discharge limit placed on the battery cell 500 is 3.2 V or 10 percent above the maximum discharge limit of the battery cell 500. Energy that is included in the battery cell 500 but is unusable due to the 3.2 V discharge limit placed on the battery cell 500 is illustrated by the portion of the battery cell 500 marked 600. Due to the discharge limit of 3.2 V, the battery cell 500 illustrated in FIG. 6A is only discharged up to a voltage of 3.2 V and has 10 percent of its energy available after reaching a discharge cutoff.

FIG. 6B illustrates the approach of placing a charge limit (e.g., a SOC limit) on a battery cell (for example, the battery cell(s) 500 of the battery stack 260) to prevent the battery cell's capacity from meeting or exceeding a threshold capacity set by a regulatory agency. In FIG. 6B, the charge limit placed on the battery cell 500 is 3.9 V or 90 percent of the maximum charge limit of the battery cell 500. Energy that the battery cell 500 is capable of storing but does not store due to the 3.9 V charge limit is illustrated as the portion of the battery cell 500 marked 605. Due to the charge limit of 3.9 V, the battery cell 500 illustrated in FIG. 6B is charged up to a voltage of 3.9 V and has 10 percent of its energy remaining to be charged.

FIG. 6C illustrates the approach of placing a charge limit and a discharge limit (e.g., SOC limits) on a battery cell (for example, the battery cell(s) 500 of the battery stack 260) to prevent the battery cell's capacity from meeting or exceeding a threshold capacity set by a regulatory agency. In FIG. 6C, the discharge limit placed on the battery cell 500 is 2.8 V or 5 percent above the maximum discharging limit of the battery cell 500. Energy that is included in the battery cell 500 but is unusable due to the 2.8 V discharging limit is illustrated as the portion of the battery cell 500 marked 610. Due to the discharging limit of 2.8 V, the battery cell 500 illustrated in FIG. 6C is only discharged up to a voltage of 2.8 V and has 5 percent of its energy available after reaching a discharge cutoff.

In FIG. 6C, the charge limit placed on the battery cell 500 to prevent the battery cell's capacity from meeting or exceeding a threshold capacity set by a regulatory agency is 4.0 V or 95 percent of the maximum charge limit of the battery cell 500. Energy that the battery cell 500 is capable of storing but does not store due to the 4.0 V charge limit is illustrated as the portion of the battery cell 500 marked 615. Due to the charging limit of 4.0 V, the battery cell 500 illustrated in FIG. 6B is charged up to a voltage of 3.9 V and has 5 percent of its energy remaining to be charged.

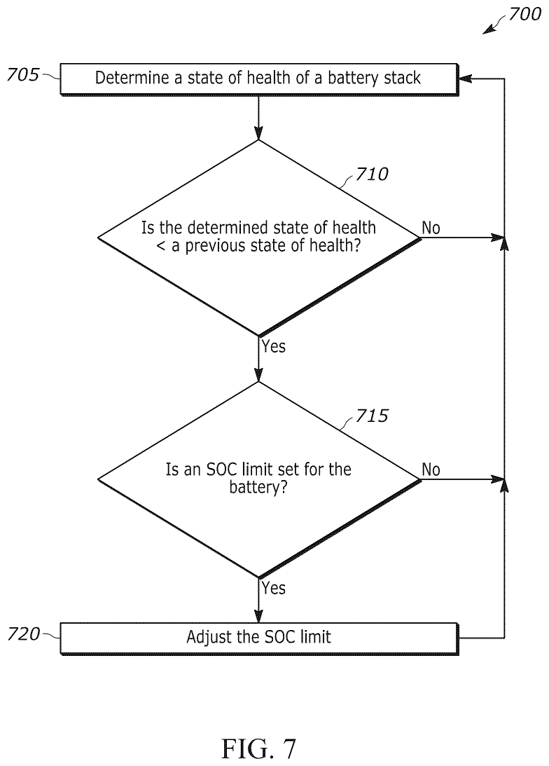

FIG. 7 provides an example illustration of a method 700 for adjusting a SOC limit of a battery stack 260 based on a state of health of the battery stack 260. In some embodiments the method 700 may be performed by the battery pack controller 200, the charger controller 400, or both. In some embodiments, the method 700 begins at block 705 when the controller 200, 400 determines a state of health of the battery stack 260. In some embodiments, prior to performing block 705, the controller 200, 400 sets an initial SOC limit for the battery stack 260. For example, the initial SOC limits may include the maximum charge and discharge limits of the battery cells 500. In addition, prior to performing block 705, the controller 400, 200 may determine an initial state of health of the battery stack 260.

In block 705, the controller 200, 400 may determine the state of health of the battery stack 260. The state of health of the battery stack 260 may be defined as 100 percent multiplied by the maximum energy the battery stack 260 can store between a SOC of 0 percent and a SOC of 100 percent divided by a measured energy of the battery stack 260 between a SOC of 0 percent and a SOC of 100 percent. The maximum energy the battery stack 260 can store between a SOC of 0 percent and a SOC of 100 percent may be the maximum amount of energy the battery stack 260 can store before it has begun to degrade without exceeding a charge limit placed on it to aid in preventing the battery stack 260 from becoming unsafe and preventing the life of the battery stack 260 being shortened or dropping below a discharge limit placed on the battery stack 260 to aid in preventing the battery stack 260 from becoming unsafe and preventing the life of the battery stack 260 being shortened. The measured energy of the battery stack 260 between a SOC of 0 percent and a SOC of 100 percent may be the maximum amount of energy the battery stack 260 can store once it has begun to degrade without exceeding a charge limit placed on it to aid in preventing the battery stack 260 from becoming unsafe and preventing the life of the battery stack 260 being shortened or dropping below a discharge limit placed on the battery stack 260 to aid in preventing the battery stack 260 from becoming unsafe and preventing the life of the battery stack 260 being shortened. For example, a new battery stack 260 may be able to store a maximum amount of energy of 100 Wh. Once the battery stack 260 ages, the ability of the battery stack 260 to store energy (the capacity of the battery stack 260) may decrease and the battery stack 260 may have a measured energy of 90 Wh. Therefore, in this example, the state of health of the battery stack 260 is =100%*(90 Wh/100 Wh)=90%.

In one embodiment, the measured energy of the battery stack 260 is determined by tracking the total amount of energy charged to the battery stack 260 or discharged from the battery stack 260 and utilizing a mapping of age of battery stack 260 to capacity of battery stack. The mapping may be stored on the memory 225, the memory 445, or both when, for example, the battery pack 100 or battery pack charger 300 is manufactured. The mapping may be determined in a lab environment when capacity of a battery stack is measured as the battery stack is repeatedly charged and discharged.

In another embodiment, the measured energy of the battery stack 260 is determined using Coulomb counting. Coulomb counting involves measuring the amount of charge that flows into and out of the battery stack 260 during charging and/or discharging cycles. In some embodiments, Coulomb counting is performed by integrating current (amps) over time (seconds) to calculate the total charge that has been transferred to or from the battery stack 260. The result of Coulomb counting is a value for the capacity of the battery stack 260 in Amp-hours (Ah). This value can be multiplied by the nominal voltage of the battery stack 260 to determine the decreased capacity or measured energy of the battery stack 260 in watt-hours (Wh). The nominal voltage of the battery stack 260 is generally a constant value.

In some embodiments, the controller 200, 400 may perform block 705 when a predetermined number of discharge cycles have been performed by the battery stack 260 or the battery stack 260 has been discharged a predetermined number of times since the block 705 was last performed by the controller 200, 400. For example, block 705 may be performed every 50 discharge cycles of the battery stack 260.

At block 710, the controller 200, 400 determines whether the determined state of health of the battery stack 260 is less than a previous state of health. The previous state of health may be the most recently determined state of health of the battery stack 260. For example, the previous state of health may be the state of health determined at block 705 during the most recent previous iteration of the method 700. In another example, when the first iteration of the method 700 is performed, the previous state of health may be the initial state of health (described above) that is determined before block 705 is performed.

When the controller 200, 400 determines that the determined state of health of the battery stack 260 is less than a previous state of health, the controller 200, 400, at block 715, may determine whether a SOC limit is set for the battery stack 260. In some embodiments, block 715 includes determining whether a charge limit less than 100 percent SOC is set for the battery stack 260, a discharge limit of greater than 0 percent SOC is set for the battery stack 260, or both a charge limit less than 100 percent SOC and a discharge limit of greater than 0 percent SOC are set for the battery stack 260.

When the controller 200, 400 determines that a SOC limit set for the battery stack 260, the controller 200, 400, at block 720, adjusts the SOC limit for the battery stack 260. That is, the controller 200, 400 increases the charge limit, reduces the discharge limit, or both increases the charge limit and reduces the discharge limit set for the battery stack 260. In some embodiments, the controller 200, 400 adjusts the SOC limit set for the battery stack 260 so that a desired amount of useable energy (or a desired capacity) is maintained for the battery stack 260. The SOC limit of the battery stack 260 is therefore adjusted based on the determined state of health of the battery stack 260.

In embodiments described herein, the controller 200, 400 may also enforce the SOC limit. Specifically, the controller 200, 400 may continuously or periodically monitor the SCO during charging and/or discharging of the battery pack 100. When the SOC of the battery stack 260 meets or exceeds the charge limit during a charging operation of the battery pack 100, the controller 200, 400 terminates charging of the battery pack 100 or battery stack 260. For example, the controller 200, 400 opens a charging FET of the battery pack 100 or battery stack 260 to terminate or stop charging. Similarly, when the SOC of the battery stack 260 meets or falls below the discharge limit during a discharging operation of the battery pack 100, the controller 200, 400 terminates discharging of the battery pack 100 or battery stack 260. For example, the controller 200, 400 opens a discharging FET of the battery pack 100 or battery stack 260 to terminate or stop charging.

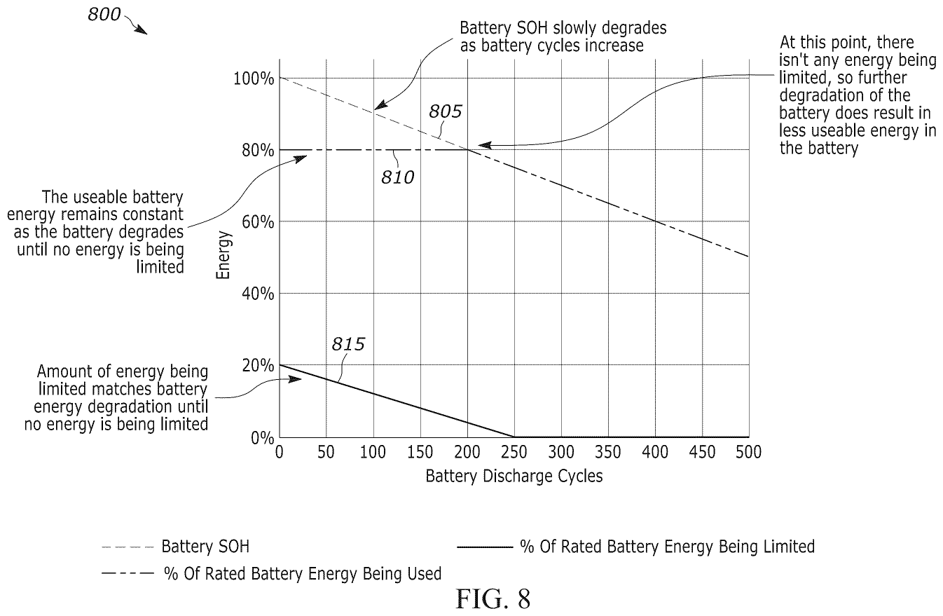

FIG. 8 provides an example graph 800 that illustrates how the state of health of a battery stack 260 effects the SOC limit set for the battery stack 260 and the percentage of the battery stack's energy that is usable. In the graph 800, the x-axis represents the number of discharge cycles that the battery stack 260 has performed or the number of times that the battery stack 260 has been discharged. The y-axis of the graph 800 represents a percentage of the battery stack's energy or capacity. The line marked 805 in the graph 800 represents the state of health of the battery stack 260, the line marked 810 represents the percentage of the battery stack's energy that is being used, and the line marked 815 represents the percentage of the battery stack's energy that is not being used due to a SOC limit set for the battery stack 260. As can be seen in the graph 800, when the battery stack 260 has not been used, the battery stack 260 is capable of storing 100 percent of the energy it is initially able to store, however, due to a SOC limit set for the battery stack 260, only 80 percent of the battery stack's energy may be useable. As the number of discharge cycles performed by the battery stack 260 increases, the state of health of the battery stack 260 declines, however, as the state of health of the battery stack 260 declines, the SOC limits set for the battery stack 260 are adjusted so that 80 percent of the battery stack's energy remains useable even as the battery stack's overall capacity or the amount of energy that the battery stack 260 is able to store decreases. After 200 discharge cycles, the SOC limits no longer limit the percentage of the battery stack's energy that is usable. However, because the state of health of the battery stack 260 continues to decrease, the percentage of the battery stack's energy that is usable will drop below 80 percent and continue to decrease as the battery stack's state of health decreases.

In some embodiments, there may be some amount of error associated with a determined state of health of the battery stack 260 because measurements utilized to determine the state of health of the battery stack 260 may be associated with some amount of error. Therefore, in embodiments where it is important that a battery stack 260 not have more than a predetermined amount of energy stored, a tolerance associated with the determined state of health may be taken into account when adjusting the SOC limit set for the battery stack 260.

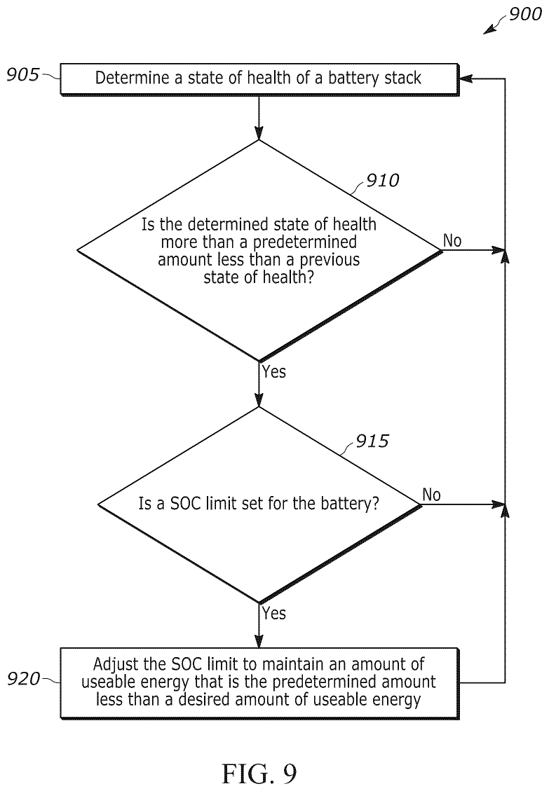

FIG. 9 provides an example flowchart of a method 900 for adjusting a SOC limit of a battery stack 260 based on a state of health of the battery stack 260, taking into account a tolerance associated with the state of health of the battery stack 260. Like the method 700 (described above), the method 900 may be performed by the battery pack controller 200, the charger controller 400, or both. In some embodiments, the method 900 begins at block 905 when the controller 200, 400 determines a state of health of a battery stack 260. The block 905 may be similar to the block 705 described above in relation to the method 700.

At block 910, the controller 200, 400 determines whether the determined state of health of the battery stack 260 is more than a predetermined amount less than a previous state of health. The previous state of health referred to in block 910 may be similar to the previous state of health described above in relation to block 710 of the method 700. In some embodiments, the predetermined amount referred to in block 910 is a tolerance value associated with the state of health of the battery stack 260. For example, if the tolerance value associated with the state of health is 5 percent, the determined state of health is 90 percent, and the previous state of health is 100 percent, the method 900 will proceed to block 915. The tolerance value associate with the state of health may be set by the manufacturer and stored in the memory 225 of the battery pack 100.

When the determined state of health of the battery stack 260 is more than a predetermined amount less than a previous state of health, at block 915, the controller 200, 400 determines whether a SOC limit set for the battery stack 260. The block 915 is similar to block 715 described above in relation to the method 700.

When a SOC limit set for the battery stack 260, at block 920, the controller 200, 400 adjusts the SOC limit to maintain an amount of useable energy that is the predetermined amount less than a desired amount of useable energy or a desired capacity. That is, the controller 200, 400 increases the charge limit, reduces the discharge limit, or increases the charge limit and reduces the discharge limit to maintain an amount of useable energy that is the predetermined amount less than a desired amount of useable energy or a desired capacity. For example, when the desired amount of usable energy is 80 percent and the tolerance value associated with the determined state of health is 5 percent, the amount of useable energy referred to in block 920 is 75 percent.

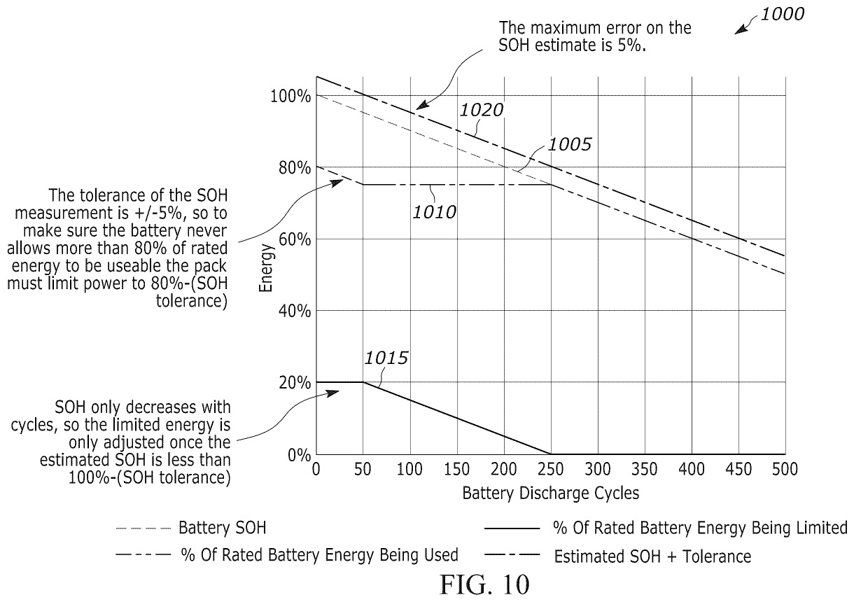

FIG. 10 provides an example graph 1000 that illustrates how the state of health of a battery stack 260 effects the SOC limit set for the battery stack 260 and the percentage of the battery stack's energy that is usable, when a tolerance associated with the state of health of the battery stack 260 is taken into account. In the graph 1000, the x-axis represents the number of discharge cycles that the battery stack 260 has performed or the number of times that the battery stack 260 has been discharged. The y-axis of the graph 1000 represents a percentage of the battery stack's energy or capacity. The line marked 1005 in the graph 1000 represents the state of health of the battery stack 260, the line marked 1010 represents the percentage of the battery stack's energy that is useable, the line marked 1015 represents the percentage of the battery stack's energy that is not being used due to SOC limits that are set for the battery stack 260, and the line marked 1020 represents the state of health of the battery stack 260 when the tolerance associated with the state of health is added to the state of health (the state of health of the battery stack 260+the tolerance). In the graph 1000, the tolerance associated with the state of health value is 5 percent and the desired amount of usable energy is 80 percent. To account for the tolerance associated with the state of health, the amount of usable energy is maintained at 75 percent or less when the state of health of the battery stack 260+the tolerance is less than or equal to 100 percent and the SOC limits set for the battery stack 260 are only adjusted when the state of health of the battery stack 260+the tolerance is less than or equal to 100 percent.

In some embodiments, the battery pack 100 may have one or modes for charging or discharging. For example, in a first mode no SOC limit is placed on the battery stack 260 included in the battery pack 100 to prevent the capacity of the battery pack 100 from meeting or exceeding a threshold capacity set by a regulatory agency. In a second mode (for example, a shipping and transportation mode), the battery pack controller 200 may place SOC limits on the battery stack 260 included in the battery pack 100 to prevent the capacity of the battery pack 100 from meeting or exceeding a threshold capacity set by a regulatory agency.

Thus, embodiments provided herein describe, among other things, systems and methods for adjusting a SOC limit of a battery stack based on a state of health of the battery stack. Various features and advantages are set forth in the following claims.

What is claimed is:

1. A battery pack comprising:
a battery stack including a plurality of battery cells connected in series; and
a controller electrically connected to the battery stack, the controller configured to:
determine a state of health of the battery stack; and
adjust a state of charge (SOC) limit for the battery stack by at least one selected from a group consisting of increasing a charge limit and reducing a discharge limit when the determined state of health is less than a previous state of health.

2. The battery pack of claim 1, wherein the SOC limit is adjusted when the determined state of health is less than a previous state of health by a predetermined amount.

3. The battery pack of claim 2, wherein the predetermined amount is a tolerance value associated with the determined state of health of the battery stack.

4. The battery pack of claim 1, wherein the controller is configured to determine a state of health of the battery stack using Coulomb counting.

5. The battery pack of claim 1, wherein the controller is configured to set an initial SOC limit for the battery stack below a maximum usable energy limit for the battery stack and wherein the SOC limit is adjusted from the initial SOC limit.

6. A battery pack comprising:
a battery stack; and
a controller electrically connected to the battery stack, the controller configured to:
determine a state of health of the battery stack; and
adjust a state of charge (SOC) limit for the battery stack based on the determined state of health.

7. The battery pack of claim 6, wherein the SOC limit is adjusted when the determined state of health is less than a previous state of health by a predetermined amount.

8. The battery pack of claim 7, wherein the predetermined amount is a tolerance value associated with the determined state of health of the battery stack.

9. The battery pack of claim 7, wherein the controller is configured to adjust the SOC limit to maintain an amount of useable energy that is the predetermined amount less than a desired amount of useable energy.

10. The battery pack of claim 6, wherein the controller is configured to determine the state of health of the battery stack based on one selected from a group consisting of a number of times the battery stack has been discharged and Coulomb counting.

11. The battery pack of claim 6, wherein the controller is configured to adjust the SOC limit for the battery stack by at least one selected from a group consisting of increasing a charge limit and reducing a discharge limit.

12. The battery pack of claim 6, wherein the controller is configured to set an initial SOC limit for the battery stack below a maximum usable energy limit for the battery stack.

13. A method for adjusting a state of charge (SOC) limit of a battery stack based on a state of health of the battery stack, the method comprising:
determining a state of health of a battery stack; and
adjusting a SOC limit for the battery stack based on the determined state of health.

14. The method of claim 13, wherein the SOC limit is adjusted when the determined state of health is less than a previous state of health by a predetermined amount.

15. The method of claim 14, wherein the predetermined amount is a tolerance value associated with the determined state of health of the battery stack.

16. The method of claim 14, wherein adjusting a SOC limit for the battery stack based on the determined state of health includes adjusting the SOC limit to maintain an amount of useable energy that is the predetermined amount less than a desired amount of useable energy.

17. The method of claim 13, wherein determining a state of health of a battery stack includes determining the state of health of the battery stack based on a number of times the battery stack has been discharged.

18. The method of claim 13, wherein determining a state of health of a battery stack includes determining a state of health of the battery stack using Coulomb counting.

19. The method of claim 13, wherein adjusting the SOC limit for the battery stack includes at least one selected from a group consisting of increasing a charge limit and reducing a discharge limit.

20. The method of claim 13, the method further comprising:
setting an initial SOC limit for the battery stack below a maximum usable energy limit for the battery stack.
